(19) United States
(12) Patent Application Publication
(10) Pub. No.: US 2017/0068024 A1
(43) Pub. Date: Mar. 9, 2017

(54) COLOR FILTER SUBSTRATE AND MANUFACTURING METHOD THEREOF

(71) Applicants: Shenzhen China Star Optoelectronics Technology Co., Ltd., Shenzhen (CN); Wuhan China Star Optoelectronics Technology Co., Ltd., Wuhan (CN)

(72) Inventor: Yong XU, Shenzhen (CN)

(21) Appl. No.: 14/891,391

(22) PCT Filed: Sep. 14, 2015
(86) PCT No.: PCT/CN2015/089530

§ 371 Date: Nov. 16, 2015

(30) Foreign Application Priority Data
Sep. 9, 2015 (CN) 201510571996.6

(51) Int. Cl. G02B 5/20

(52) U.S. Cl. CPC G02B 5/201

(57) ABSTRACT

A color filter substrate is provided, and includes a glass substrate, a color filter layer and a planar layer. The color filter layers include three color barrier layers and two light-shading layers. Two of the light-shading layers overlap in light-shading regions. A manufacturing method of a color filter substrate is provided, and includes sequentially forming three color barrier layers on a glass substrate, wherein a part of one of a first color barrier layer or a second color barrier layer forms a first light-shading layer, and a part of a third color barrier layer forms a second light-shading layer.

### FIELD OF THE INVENTION

The present invention relates to the technical field of displays, and in particular to a color filter substrate and a manufacturing method thereof.

### BACKGROUND OF THE INVENTION

With the progress of the time, the development of the liquid crystal display technology is also growing fast, and polysilicon technology with high mobility and a high aperture ratio has gradually replaced the conventional amorphous silicon technology, and has been widely welcomed by the public. However, the manufacturing process of the polysilicon technology is very complex, and the production is difficult. For example, the production of the color filter substrate of the liquid crystal display panel in a prior art is complex, and the number of the required masks is great, since in the color filter substrate layer in the prior art, a black matrix requires to be formed on the glass substrate for shading, otherwise a light leakage phenomenon appears on the convergences between different color barriers, namely the light-shading regions, thereby reducing the display quality of the liquid crystal display panel. However, the method for forming a black matrix on a glass substrate in the prior art increases the number of the masks in the manufacturing process of the color filter substrate, uses more materials for manufacturing the black matrix and complicates the manufacturing process. Furthermore, the shading effect of the black matrix is not good enough so that light leakage phenomenon appears often. The problem in the prior art urgently needs to be resolved.

### SUMMARY OF THE INVENTION

The purpose of the present invention is to provide a color filter substrate which can replace the black matrix and achieve the shading effect. The present invention also provides a method for producing a color filter substrate which can reduce the number of masks in the manufacture of the color filter substrate.

The technical solutions of the present invention is as follows:

A color filter substrate comprises:
a glass substrate;
a color filter layer formed on the glass substrate; and
a planar layer formed on the color filter layer;
wherein the glass substrate is provided with light-shading regions and light-transmissive regions;
the color filter layer includes a first color barrier layer, a second color barrier layer, a third color barrier layer, a first light-shading layer, and a second light-shading layer formed on the glass substrate;
the first light-shading layer covers the light-shading regions;
the second light-shading layer covers the first light-shading layer;
the first light-shading layer and the second light-shading layer form an overlapped light-shading layer;
the overlapped light-shading layer is configured to block light;
the first color barrier layer, the second color barrier layer, and the third color barrier layer cover the light-transmissive regions;
the first color barrier layer, the second color barrier layer and the third color barrier layer do not overlap each other;
the light-shading regions are regions between two of the first color barrier layer, the second color barrier layer, and the third color barrier layer;
the light-transmissive regions are regions other than the light-shading regions;
the material of the first light-shading layer or the second light-shading layer is identical to the material of one of the first color barrier layer, the second color barrier layer, and the third color barrier layer; and
the material of the first light-shading layer is different from the material of the second light-shading layer.

Preferably, the colors of two of the first color barrier layer, the second color barrier layer, and the third color barrier layer are different, and the colors thereof are respectively one of red, green, and blue.

Preferably, the thicknesses of two of the first color barrier layer, the second color barrier layer and the third color barrier are equivalent, and the thickness of the other color barrier layer is greater than the equivalent thicknesses of two of the color barrier layers.

Preferably, the thickness of the first light-shading layer is equivalent to the equivalent thicknesses of two of the color barrier layers, and the sum of the thickness of the first light-shading layer and the thickness of the second light-shading layer is equivalent to the greater thickness of the other color barrier layer.

Preferably, pads are formed on the planar layer, and the pads are disposed on corresponding locations of the light-shading regions.

A manufacturing method of a color filter substrate comprises:
a step of sequentially forming a first color barrier layer, a second color barrier layer and a third color barrier layer on a glass substrate, the first color barrier layer, the second color barrier layer and the third color barrier layer covering light-transmissive regions on the glass substrate;
wherein when the first color barrier layer and the second color barrier layer are formed, a part of one of the first color barrier layer or the second color barrier layer covers light-shading regions on the glass substrate to form a first light-shading layer;
when the third color barrier layer is formed, a part of the third color barrier layer covers the first light-shading layer to form a second light-shading layer;
the light-shading regions are regions between two of the first color barrier layer, the second color barrier layer and the third color barrier layer;
the light-transmissive regions are regions other than the light-shading regions;
the colors of two of the first color barrier layer, the second color barrier layer and the third color barrier layer are different, and the colors thereof are respectively one of red, green, and blue.

Preferably, the manufacturing method further comprises a step of forming a planar layer on the glass substrate which covers the first color barrier layer, the second color barrier layer, the third color barrier layer, the first light-shading layer, and the second shading layer.

Preferably, the thicknesses of two of the first color barrier layer, the second color barrier layer, and the third color barrier are equivalent, and the thickness of the other color barrier layer is greater than the equivalent thicknesses of two of the color barrier layers.

Preferably, the thickness of the first light-shading layer is equivalent to the equivalent thicknesses of two of the color barrier layers, and the sum of the thickness of the first light-shading layer and the thickness of the second light-shading layer is equivalent to the greater thickness of the other color barrier layer.

Preferably, the manufacturing method further comprises a step of forming pads on the planar layer, wherein the pads are disposed on corresponding locations of the light-shading regions.

A color filter substrate, comprises:
a glass substrate;
a color filter layer formed on the glass substrate; and
a planar layer formed on the color filter layer;
   wherein the glass substrate is provided with light-shading regions and light-transmissive regions;
the color filter layer includes a first color barrier layer, a second color barrier layer, a third color barrier layer, a first light-shading layer, and a second light-shading layer formed on the glass substrate;
the first light-shading layer covers the light-shading regions;
the second light-shading layer covers the first light-shading layer;
the first light-shading layer and the second light-shading layer form an overlapped light-shading layer;
the overlapped light-shading layer is configured to block light;
the first color barrier layer, the second color barrier layer, and the third color barrier layer cover the light-transmissive regions;
the first color barrier layer, the second color barrier layer, and the third color barrier layer do not overlap each other;
the light-shading regions are regions between two of the first color barrier layer, the second color barrier layer and the third color barrier layer; and
the light-transmissive regions are regions other than the light-shading regions.

Preferably, the material of the first light-shading layer or the second light-shading layer is identical to the material of one of the first color barrier layer, the second color barrier layer, and the third color barrier layer; and the material of the first light-shading layer is different from the material of the second light-shading layer.

Preferably, the colors of two of the first color barrier layer, the second color barrier layer, and the third color barrier layer are different, and the colors thereof are respectively one of red, green, and blue.

Preferably, the thicknesses of two of the first color barrier layer, the second color barrier layer, and the third color barrier are equivalent, and the thickness of the other color barrier layer is greater than the equivalent thicknesses of two of the color barrier layers.

Preferably, the thickness of the first light-shading layer is equivalent to the equivalent thicknesses of two of the color barrier layers, and the sum of the thickness of the first light-shading layer and the thickness of the second light-shading layer is equivalent to the greater thickness of the other color barrier layer.

Preferably, pads are formed on the planar layer, and the pads are disposed on corresponding locations of the light-shading regions.

A manufacturing method of a color filter substrate, comprises a step of:
sequentially forming a first color barrier layer, a second color barrier layer, and a third color barrier layer on a glass substrate, the first color barrier layer, the second color barrier layer and the third color barrier layer covering light-transmissive regions on the glass substrate;
wherein when the first color barrier layer and the second color barrier layer are formed, a part of one of the first color barrier layer or the second color barrier layer covers light-shading regions on the glass substrate to form a first light-shading layer;
when the third color barrier layer is formed, a part of the third color barrier layer covers the first light-shading layer to form a second light-shading layer;
the light-shading regions are regions between two of the first color barrier layer, the second color barrier layer and the third color barrier layer; and
the light-transmissive regions are regions other than the light-shading regions.

Preferably, the colors of two of the first color barrier layer, the second color barrier layer and the third color barrier layer are different; and the colors thereof are respectively one of red, green, and blue.

Preferably, the manufacturing method further comprises a step of forming a planar layer on the glass substrate which covers the first color barrier layer, the second color barrier layer, the third color barrier layer, the first light-shading layer, and the second light-shading layer.

Preferably, the manufacturing method further comprises a step of forming pads on the planar layer, wherein the pads are disposed on corresponding locations of the light-shading regions.

The beneficial effect of the present invention is as follows:

In a color filter substrate of the present invention, a laminated structure of color barriers with two different colors is used to replace a black matrix for achieving the shading effect. In a manufacturing method of a color filter substrate of the present invention, the manufacture of a black matrix is omitted, so as to reduce the number of the masks for manufacturing the color filter substrate, as well as to achieve an excellent shading effect.

### BRIEF DESCRIPTION OF THE DRAWINGS

FIG. 1 is a schematic diagram of a cross-sectional structure of a color filter substrate in accordance with an embodiment of the present invention.

FIG. 2 is a flow chart of a manufacturing method of a color filter substrate in accordance with an embodiment of the present invention.

### DETAILED DESCRIPTION OF THE PREFERRED EMBODIMENTS

The following description of the embodiments with reference to the accompanying drawings is used to illustrate particular embodiments of the present invention. The directional terms referred in the present invention, such as “upper”, “lower”, “front”, “back”, “left”, “right”, “inner”, “outer”, “side”, etc. are only directions with regard to the accompanying drawings. Therefore, the directional terms used for describing and illustrating the present invention are not intended to limit the present invention. In the drawings, units with similar structures are indicated by the same reference number.

### First Embodiment

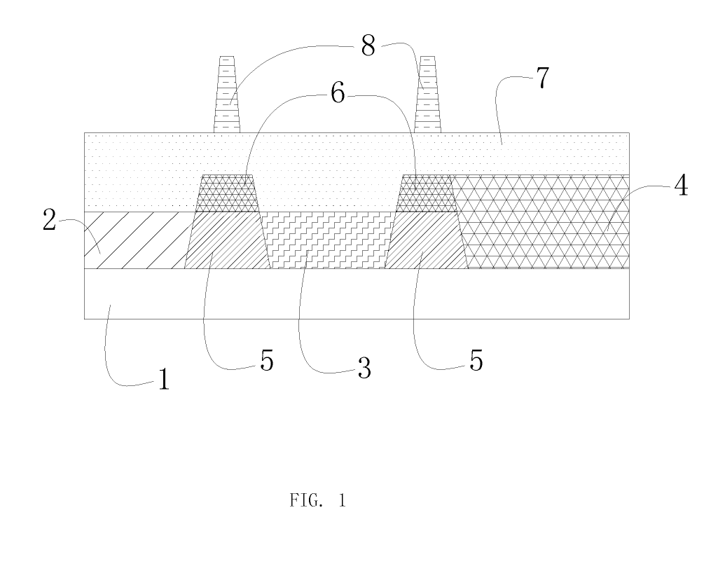

FIG. 1 is a cross-sectional structure of a schematic view of a color filter substrate in accordance with an embodiment of the present invention. In FIG. 1, the color filter substrate of the present embodiment includes a glass substrate 1, a color filter layer formed on the glass substrate 1, and a planar layer 7 formed on the color filter layer.

The glass substrate 1 is provided with light-shading regions and light-transmissive regions. The color filter layer includes a first color barrier layer 2, a second color barrier layer 3, a third color barrier layer 4, a first light-shading layer 5 and a second light-shading layer 6 formed on the glass substrate 1. The first light-shading layer 5 covers the light-shading regions. The second light-shading layer 6 covers the first light-shading layer 5. The first light-shading layer 5 and the second light-shading layer 6 form an overlapped light-shading layer. The overlapped light-shading layer is configured to block light. The first color barrier layer 2, the second color barrier layer 3, and the third color barrier layer 4 cover the light-transmissive regions. The first color barrier layer 2, the second color barrier layer 3, and the third color barrier layer 4 do not overlap each other. The light-shading regions are regions between two of the first color barrier layer 2, the second color barrier layer 3, and the third color barrier layer 4. The light-transmissive regions are regions other than the light-shading regions.

In the preferred embodiment, the material of the first light-shading layer 5 or the second light-shading layer 6 is identical to the material of one of the first color barrier layer 2, the second color barrier layer 3, and the third color barrier layer 4, and the material of the first light-shading layer 5 is different from the material of the second light-shading layer 6. In the preferred embodiment, the colors of two of the first color barrier layer 2, the second color barrier layer 3, and the third color barrier layer 4 are different, and the colors thereof are respectively one of red, green, and blue.

In the preferred embodiment, the thicknesses of two of the first color barrier layer 2, the second color barrier layer 3, and the third color barrier 4 are equivalent, and the thickness of the other color barrier layer is greater than the equivalent thicknesses of two of the color barrier layers.

In the preferred embodiment, the thickness of the first light-shading layer 5 is equivalent to the equivalent thicknesses of two of the color barrier layers, and the sum of the thickness of the first light-shading layer 5 and the thickness of the second light-shading layer 6 is equivalent to the greater thickness of the other color barrier layer.

For saving the time of using the materials of the color barrier layers and the patterning process, for a particular instance, the thickness of the first color barrier layer 2 and the thickness of the second color barrier layer 3 are equivalent in the present preferred embodiment, and the thickness of the third color barrier layer 4 is greater than the first color barrier layer 2. More preferably, the thickness of the second light-shielding layer 6 is less than the thickness of the first light-shielding layer 5. The sum of the thickness of the first light-shielding layer 5 and the thickness of the second light-shielding layer 6 is equivalent to the thickness of the third color barrier layer 4.

Finally, in the present embodiment, pads 8 are disposed on the planar layer 7, and the pads 8 are disposed on corresponding locations of the light-shading regions. The pads 8 in the present embodiment are divided into supporting pads 8 and cushioning pads 8 for the comprehensive protection for the color filter substrate.

The shading principle of the present invention is as follows:

If the color of the first light-shielding layer 5 is red, and the color of the second light-shielding layer 6 is blue, then the first light-shielding layer 5 only allows red light to transmit therethrough, and absorbs green and blue light. At this time, the red light transmitted through the first light-shielding layer 5 is irradiated on the second light-shielding layer 6. Since the color of the second light-shielding layer 6 is blue, the second light-shielding layer 6 absorbs the red light irradiated thereon, so that the overlapped light-shielding layer formed by the first light-shielding layer 5 and the second light-shielding layer 6 can effectively prevent the light leakage of the color filter substrate.

### Second Embodiment

A manufacturing method of a color filter substrate of the present embodiment includes step of sequentially forming a first color barrier layer 2, a second color barrier layer 3, and a third color barrier layer 4 on a glass substrate 1. The first color barrier layer 2, the second color barrier layer 3 and the third color barrier layer 4 cover light-transmissive regions on the glass substrate 1.

When the first color barrier layer 2 and the second color barrier layer 3 are formed, a part of one of the first color barrier layer 2 or the second color barrier layer 3 covers light-shading regions on the glass substrate 1 to form a first light-shading layer 5. When the third color barrier layer 4 is formed, a part of the third color barrier layer 4 covers the first light-shading layer 5 to form a second light-shading layer 6. The light-shading regions are regions between two of the first color barrier layer 2, the second color barrier layer 3, and the third color barrier layer 4. The light-transmissive regions are regions other than the light-shading regions.

In the preferred embodiment, the colors of two of the first color barrier layer 2, the second color barrier layer 3 and the third color barrier layer 4 are different, and the colors thereof are respectively one of red, green, and blue.

In the preferred embodiment, the step further includes forming a planar layer 7 over the glass substrate 1 which covers the first color barrier layer 2, the second color barrier layer 3, the third color barrier layer 4, the first light-shading layer 5 and the second shading layer 6.

In the preferred embodiment, the step further includes forming pads 8 on the planar layer 7, wherein the pads 8 are disposed on the corresponding locations of the light-shading regions.

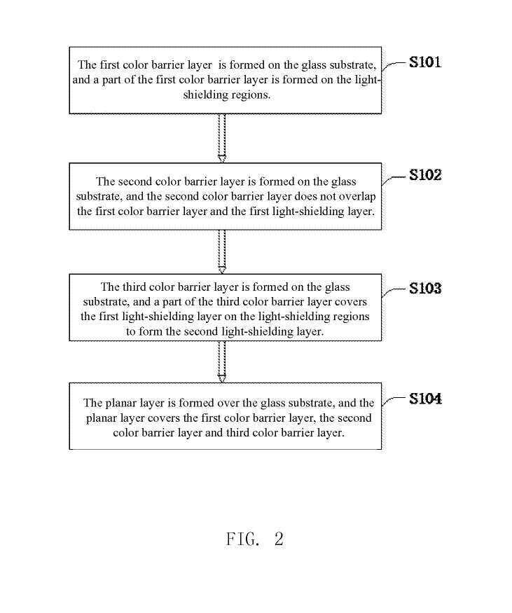

For instance, in the embodiment, it is assumed that when the first color barrier layer 2 is formed, a part of the first color barrier layer 2 covers the light-shading regions to form a first light-shading layer 5. FIG. 2 is a flow chart of a manufacturing method of a color filter substrate in accordance with an embodiment of the present invention. In FIG. 2, the method of the present embodiment includes the following steps:

Step S101: the first color barrier layer 2 is formed on the glass substrate 1, and a part of the first color barrier layer 2 is formed on the light-shielding regions.

Step S102: the second color barrier layer 3 is formed on the glass substrate 1, and the second color barrier layer 3 does not overlap the first color barrier layer 2 and the first light-shielding layer 5. In this step, the method, in which the second color barrier layer 3 does not overlap the first color barrier layer 2 and the first light-shielding layer 5, saves the material of the second color barriers layer 3 as well as the work of the patterning process.

Step S103: the third color barrier layer 4 is formed on the glass substrate 1, and a part of the third color barrier layer 4 covers the first light-shielding layer 5 on the light-shielding regions to form the second light-shielding layer 6. Thus, the first light-shielding layer 5 and the second light-shielding layer 6 overlap on the light-shielding regions. The first light-shielding layer 5 is in a lower position, that is, the first light-shielding layer 5 contacts the glass substrate 1, and the second light-shielding layer 6 covers the first light-shielding layer 5. Performing this step saves the work of the patterning process.

Step S104: the planar layer 7 is formed over the glass substrate 1, and the planar layer 7 covers the first color barrier layer 2, the second color barrier layer 3 and third color barrier layer 4. The purpose of this step is to make the surface of the color filter layer flat, since the overlapped color barrier layer formed by the first color barrier layer 2 and the third color barrier layer 4 results in an uneven surface of the color filter layer.

In summary, although the preferred embodiments of the present invention have been disclosed above, the embodiments are not intended to limit the present invention. A person of ordinary skill in the art, without departing from the spirit and scope of the present invention, can make various modifications and variations. Therefore, the scope of the invention is defined in the claims.

1. A color filter substrate, comprising:
a glass substrate;
a color filter layer formed on the glass substrate; and
a planar layer formed on the color filter layer;
wherein the glass substrate is provided with light-shading regions and light- transmissive regions;
the color filter layer includes a first color barrier layer, a second color barrier layer, a third color barrier layer, a first light-shading layer, and a second light-shading layer formed on the glass substrate;
the first light-shading layer covers the light-shading regions;
the second light-shading layer covers the first light-shading layer;
the first light-shading layer and the second light-shading layer form an overlapped light-shading layer;
the overlapped light-shading layer is configured to block light;
the first color barrier layer, the second color barrier layer and the third color barrier layer cover the light-transmissive regions;
the first color barrier layer, the second color barrier layer and the third color barrier layer do not overlap each other;
the light-shading regions are regions between two of the first color barrier layer, the second color barrier layer, and the third color barrier layer;
the light-transmissive regions are regions other than the light-shading regions;
the material of the first light-shading layer or the second light-shading layer is identical to the material of one of the first color barrier layer, the second color barrier layer, and the third color barrier layer; and
the material of the first light-shading layer is different from the material of the second light-shading layer.

2. The color filter substrate as claimed in claim 1, wherein the colors of two of the first color barrier layer, the second color barrier layer, and the third color barrier layer are different, and the colors thereof are respectively one of red, green, and blue.

3. The color filter substrate as claimed in claim 1, wherein the thicknesses of two of the first color barrier layer, the second color barrier layer, and the third color barrier are equivalent, and the thickness of the other color barrier layer is greater than the equivalent thicknesses of two of the color barrier layers.

4. The color filter substrate as claimed in claim 3, wherein the thickness of the first light-shading layer is equivalent to the equivalent thicknesses of two of the color barrier layers, and the sum of the thickness of the first light-shading layer and the thickness of the second light-shading layer is equivalent to the greater thickness of the other color barrier layer.

5. The color filter substrate as claimed in claim 1, wherein pads are formed on the planar layer, and the pads are disposed on corresponding locations of the light-shading regions.

6-10. (canceled)

11. A color filter substrate, comprising:
a glass substrate;
a color filter layer formed on the glass substrate; and
a planar layer formed on the color filter layer;
wherein the glass substrate is provided with light-shading regions and light-transmissive regions;
the color filter layer includes a first color barrier layer, a second color barrier layer, a third color barrier layer, a first light-shading layer, and a second light-shading layer formed on the glass substrate;
the first light-shading layer covers the light-shading regions;
the second light-shading layer covers the first light-shading layer;
the first light-shading layer and the second light-shading layer form an overlapped light-shading layer;
the overlapped light-shading layer is configured to block light;
the first color barrier layer, the second color barrier layer and the third color barrier layer cover the light-transmissive regions;
the first color barrier layer, the second color barrier layer, and the third color barrier layer do not overlap each other;
the light-shading regions are regions between two of the first color barrier layer, the second color barrier layer, and the third color barrier layer; and
the light-transmissive regions are regions other than the light-shading regions.

12. The color filter substrate as claimed in claim 11, wherein:
the material of the first light-shading layer or the second light-shading layer is identical to the material of one of the first color barrier layer, the second color barrier layer, and the third color barrier layer; and
the material of the first light-shading layer is different from the material of the second light-shading layer.

13. The color filter substrate as claimed in claim 11, wherein the colors of two of the first color barrier layer, the second color barrier layer, and the third color barrier layer are different, and the colors thereof are respectively one of red, green, and blue.

14. The color filter substrate as claimed in claim 11, wherein the thicknesses of two of the first color barrier layer, the second color barrier layer, and the third color barrier are equivalent, and the thickness of the other color barrier layer is greater than the equivalent thicknesses of two of the color barrier layers.

15. The color filter substrate as claimed in claim 14, wherein the thickness of the first light-shading layer is equivalent to the equivalent thicknesses of two of the color barrier layers, and the sum of the thickness of the first light-shading layer and the thickness of the second light-shading layer is equivalent to the greater thickness of the other color barrier layer.

16. The color filter substrate as claimed in claim 11, wherein pads are formed on the planar layer, and the pads are disposed on corresponding locations of the light-shading regions.

17. A manufacturing method of a color filter substrate comprising:
providing a glass substrate,
sequentially forming a first color barrier layer, a second color barrier layer and a third color barrier layer on the glass substrate, the first color barrier layer, the second color barrier layer and the third color barrier layer covering light-transmissive regions of the glass substrate;
wherein when the first color barrier layer and the second color barrier layer are formed, a part of one of the first color barrier layer or the second color barrier layer covers light-shading regions of the glass substrate to form a first light-shading layer;
when the third color barrier layer is formed, a part of the third color barrier layer covers the first light-shading layer to form a second light-shading layer;
the light-shading regions are regions between two of the first color barrier layer, the second color barrier layer and the third color barrier layer; and
the light-transmissive regions are regions other than the light-shading regions.

18. The manufacturing method as claimed in claim 17, wherein:
the colors of two of the first color barrier layer, the second color barrier layer and the third color barrier layer are different, and the colors thereof are respectively one of red, green, and blue.

19. The manufacturing method as claimed in claim 17, further comprising a step of:
forming a planar layer over the glass substrate which covers the first color barrier layer, the second color barrier layer, the third color barrier layer, the first light- shading layer, and the second shading layer.

20. The manufacturing method as claimed in claim 17, further comprising a step of:
forming pads on the planar layer, wherein the pads are disposed on corresponding locations of the light-shading regions.

21. The manufacturing method as claimed in claim 17, wherein the thicknesses of two of the first color barrier layer, the second color barrier layer, and the third color barrier are equivalent, and the thickness of the other color barrier layer is greater than the equivalent thicknesses of two of the color barrier layers.

22. The color filter substrate as claimed in claim 17, wherein the thickness of the first light-shading layer is equivalent to the equivalent thicknesses of two of the color barrier layers, and the sum of the thickness of the first light-shading layer and the thickness of the second light-shading layer is equivalent to the greater thickness of the other color barrier layer.
